(19) United States
(12) Patent Application Publication
(10) Pub. No.: US 2024/0241899 A1
(43) Pub. Date: Jul. 18, 2024

(54) INFORMATION PROCESSING APPARATUS AND INFORMATION PROCESSING METHOD

(71) Applicant: SONY GROUP CORPORATION, TOKYO (JP)

(72) Inventors: CHIAKI HIGASHINAKA, TOKYO (JP); SAYA SUZUKI, TOKYO (JP); MAKOTO YODA, TOKYO (JP); HIROMI KURASAWA, TOKYO (JP)

(21) Appl. No.: 18/551,046

(22) PCT Filed: Feb. 14, 2022
(86) PCT No.: PCT/JP2022/005566

§ 371 Date: Sep. 18, 2023

(30) Foreign Application Priority Data
Mar. 26, 2021 (JP) 2021-054157

(51) Int. Cl. G06F 16/35; G06F 16/33

(52) U.S. Cl. CPC G06F 16/353; G06F 16/334

(57) ABSTRACT

An information processing apparatus according to an embodiment includes: a score calculation unit (130) configured to calculate a score indicating a target character likeness of first content data based on a feature amount indicating a feature of the first content data and a degree of association of the target character with other characters different from the target character with respect to the first content data, and an extraction unit (140) configured to extract data to be associated with the target character among the first content data based on the score calculated by the score calculation unit.

### FIELD

The present disclosure relates to an information processing apparatus and an information processing method.

### BACKGROUND

There is known a technology that enables interaction between a user and artificial intelligence via a network such as the Internet, and further enhances a relationship between the user and the artificial intelligence by imparting a character characteristic to the artificial intelligence.

In order to generate an interactive response resembling a specific character, it is necessary to prepare an utterance text of the specific character as learning data for response generation. The utterance text of the character can be obtained from a novel, an animation script, or the like, but an amount of obtained data is very small, and it is difficult to use the utterance text as the learning data for interactive response generation.

Therefore, in order to increase the utterance text having a specific feature such as a character likeness, a method of manually creating text data using crowdsourcing or the like has been proposed (for example, Non Patent Literature 1).

### CITATION LIST

### Non Patent Literature

Non Patent Literature 1: Zhang, Saizheng, et al., “Personalizing Dialogue Agents: I have a dog, do you have pets too?.”, Proceedings of the 56th Annual Meeting of the Association for Computational Linguistics, 2018, Volume 1: Long Papers

### SUMMARY

### Technical Problem

However, manual data creation takes time, and it is difficult to collect a large amount of data in a short period of time.

An object of the present disclosure is to provide an information processing apparatus and an information processing method capable of easily collecting an utterance text having a specific feature.

### Solution to Problem

For solving the problem described above, an information processing apparatus according to one aspect of the present disclosure has a score calculation unit configured to calculate a score indicating a target character likeness of first content data based on a feature amount indicating a feature of the first content data and a degree of association of the target character with other characters different from the target character with respect to the first content data; and an extraction unit configured to extract data to be associated with the target character among the first content data based on the score calculated by the score calculation unit.

### BRIEF DESCRIPTION OF DRAWINGS

FIG. 1 is a schematic diagram illustrating a configuration of an example of an information processing system applicable to an embodiment.

FIG. 2 is a functional block diagram of an example for describing functions of an information processing system 1 according to the embodiment.

FIG. 3 is a flowchart of an example schematically illustrating processing by the information processing system according to the embodiment.

FIG. 4 is a block diagram illustrating a hardware configuration of an example of a server applicable to the embodiment.

FIG. 5 is a block diagram illustrating a hardware configuration of an example of a terminal apparatus applicable to the embodiment.

FIG. 6 is a schematic diagram illustrating an example of large-scale text data stored in a large-scale text data storage unit applicable to the embodiment.

FIG. 7 is a schematic diagram illustrating an example of line data stored in a line data storage unit applicable to the embodiment.

FIG. 8 is a flowchart illustrating an example of processing by a speaker character determination unit according to the embodiment.

FIG. 9 is a schematic diagram illustrating an example of a result of speaker character determination processing by a speaker character determination unit 110 according to the embodiment.

FIG. 10 is a schematic diagram illustrating an example of a determination result of presence or absence of versatility by a versatility determination unit according to the embodiment.

FIG. 11 is a flowchart illustrating an example of processing by a character score calculation unit according to the embodiment.

FIG. 12 is a schematic diagram illustrating an example of a character score acquisition result by the character score calculation unit according to the embodiment.

FIG. 13 is a schematic diagram illustrating an example of a data extraction screen as a user interface generated and presented by a data extraction unit applicable to the embodiment.

FIG. 14 is a schematic diagram for describing data extraction processing by the data extraction unit according to the embodiment.

FIG. 15 is a schematic diagram illustrating an example of an utterance text viewing screen according to the embodiment.

FIG. 16 is a schematic diagram illustrating another example of the utterance text viewing screen according to the embodiment.

FIG. 17 is a schematic diagram illustrating an example of target character text data output by the data extraction unit according to the embodiment.

FIG. 18 is a flowchart of an example illustrating processing by a character score calculation unit according to a second modification of the embodiment.

### DESCRIPTION OF EMBODIMENTS

Hereinafter, an embodiment of the present disclosure will be described in detail with reference to the drawings. In the following embodiment, the same parts are denoted by the same reference numerals, and redundant description will be omitted.

Hereinafter, the embodiment of the present disclosure will be described in the following order.
1. Summary of the present disclosure
2. Overall configuration example according to embodiment
3. Details of processing according to embodiment
3-1. Processing by speaker character determination unit
3-2. Processing by versatility determination unit
3-3. Processing by character score calculation unit
3-4. Processing by data extraction unit
4. First modification of embodiment
5. Second modification of embodiment
6. Third modification of embodiment

### 1. Overview of Present Disclosure

In the present disclosure, for example, by associating each of one or more characters appearing in a specific work (referred to as a target work) with each text data as content data collected in a large amount from the Internet or the like, utterances of the characters can be automatically generated.

More specifically, in the present disclosure, for an utterance text (first content data) included in text data (referred to as large-scale text data) collected in a large amount from the Internet or the like, a score indicating a target character likeness among the characters of the target work is calculated. The score is calculated based on a feature amount indicating a feature of the utterance text and a degree of association of each character included in the target work with the utterance text. Based on the calculated score, an utterance text to be associated with the target character is extracted from the large-scale text data.

Since the present disclosure has such a configuration, it is possible to easily collect an utterance text having a specific feature.

### 2. Overall Configuration Example According to Embodiment

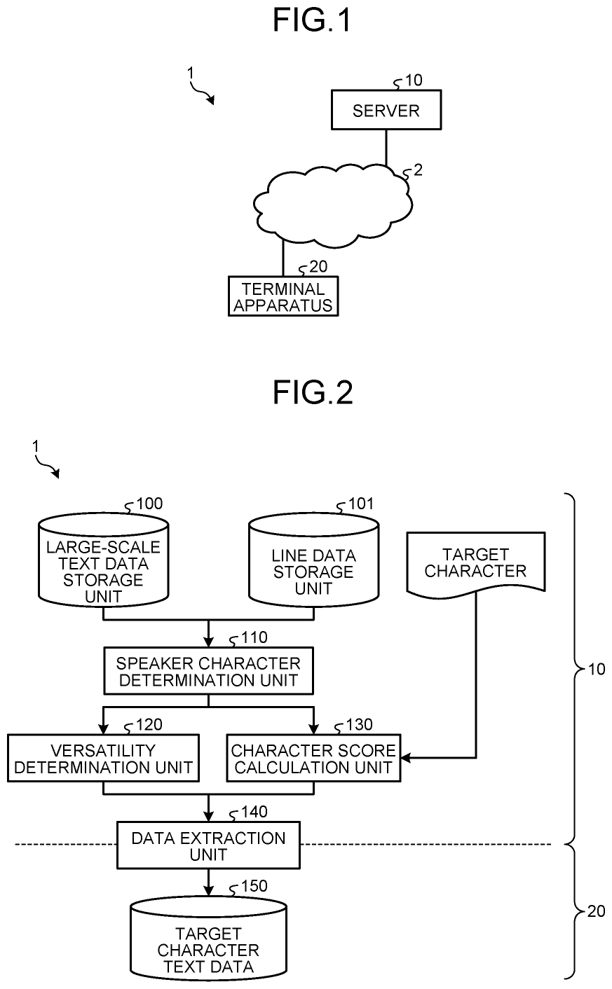

Next, an overall configuration example according to the embodiment of the present disclosure will be described. FIG. 1 is a schematic diagram illustrating a configuration of an example of an information processing system applicable to the embodiment.

In FIG. 1, an information processing system 1 according to the embodiment includes a server 10 and a terminal apparatus 20 coupled to each other via a network 2 that is, for example, the Internet. The server 10 may be a single computer or a plurality of computers coupled by a cloud computing technology.

The terminal apparatus 20 is, for example, a personal computer. Furthermore, the terminal apparatus 20 may be a computer configured to be easily carried, such as a tablet computer or a smartphone. The terminal apparatus 20 is coupled to the network 2 by priority or wireless communication.

FIG. 2 is a functional block diagram of an example for describing functions of the information processing system 1 according to the embodiment. In FIG. 2, the information processing system 1 includes a large-scale text data storage unit 100, a line data storage unit 101, a speaker character determination unit 110, a versatility determination unit 120, a character score calculation unit 130, and a data extraction unit 140. The information processing system 1 includes the large-scale text data storage unit 100, the line data storage unit 101, the speaker character determination unit 110, the versatility determination unit 120, the character score calculation unit 130, and the data extraction unit 140, and configures an information processing apparatus as a whole. Among them, a portion of the data extraction unit 140 is included in the terminal apparatus 20, and a remaining portion is included in the server 10.

The speaker character determination unit 110, the versatility determination unit 120, the character score calculation unit 130, and the data extraction unit 140 are configured by, for example, executing an information processing program according to the embodiment on a central processing unit (CPU). Not limited to this, a portion or all of the speaker character determination unit 110, the versatility determination unit 120, the character score calculation unit 130, and the data extraction unit 140 may be configured by hardware circuits that cooperate with each other.

The large-scale text data storage unit 100 stores large-scale text data including a large number of pieces of utterance data described above. The line data storage unit 101 stores line data indicating a line by each character appearing in the target work. Specific examples of the data stored in the large-scale text data storage unit 100 and the line data storage unit 101 will be described later.

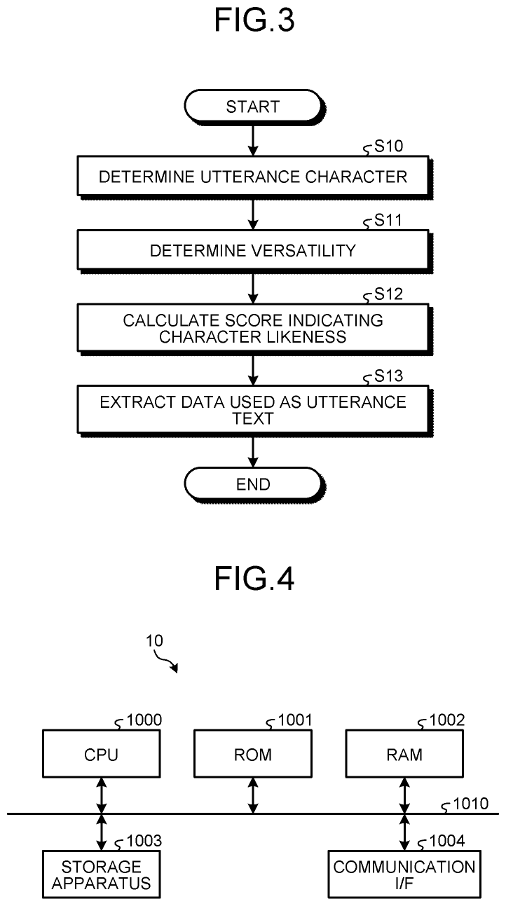

FIG. 3 is a flowchart of an example schematically illustrating processing by the information processing system 1 according to the embodiment. Note that prior to processing of the flowchart of FIG. 3, the large-scale text data storage unit 100 stores a large amount of large-scale text data collected via the Internet or the like. Furthermore, the line data storage unit 101 stores text data of lines of all characters appearing in the target work. Specific examples of the large-scale text data stored in the large-scale text data storage unit 100 and the line data stored in the line data storage unit 101 will be described later.

In FIG. 3, in step S10, the speaker character determination unit 110 determines whether each utterance text included in the large-scale text data stored in the large-scale text data storage unit 100 is likely to be an utterance of each character based on the line text (second content data) of each character stored in the line data storage unit 101. In the next step S11, the versatility determination unit 120 determines whether each utterance text has versatility. In the next step S12, the character score calculation unit 130 calculates a score indicating a target character likeness of each utterance text. In the next step S13, the data extraction unit 140 extracts target character text data 150 to be used as the utterance text of the target character based on the processing results of the speaker character determination unit 110, the versatility determination unit 120, and the character score calculation unit 130.

FIG. 4 is a block diagram illustrating a hardware configuration of an example of the server 10 applicable to the embodiment. Here, the description will be given assuming that the server 10 is configured by a single computer. In FIG. 4, the server 10 includes a central processing unit (CPU) 1000, a read only memory (ROM) 1001, a random access memory (RAM) 1002, a storage apparatus 1003, and a communication interface (I/F) 1004 which are communicably coupled to each other by a bus 1010.

The storage apparatus 1003 is a nonvolatile storage medium such as a hard disk drive or a flash memory. The CPU 1000 controls an operation of the server 10 by using the RAM 1002 as a work memory according to a program stored in the ROM 1001 and the storage apparatus 1003. The communication I/F 1004 performs communication via the network 2 under the control of the CPU 1000.

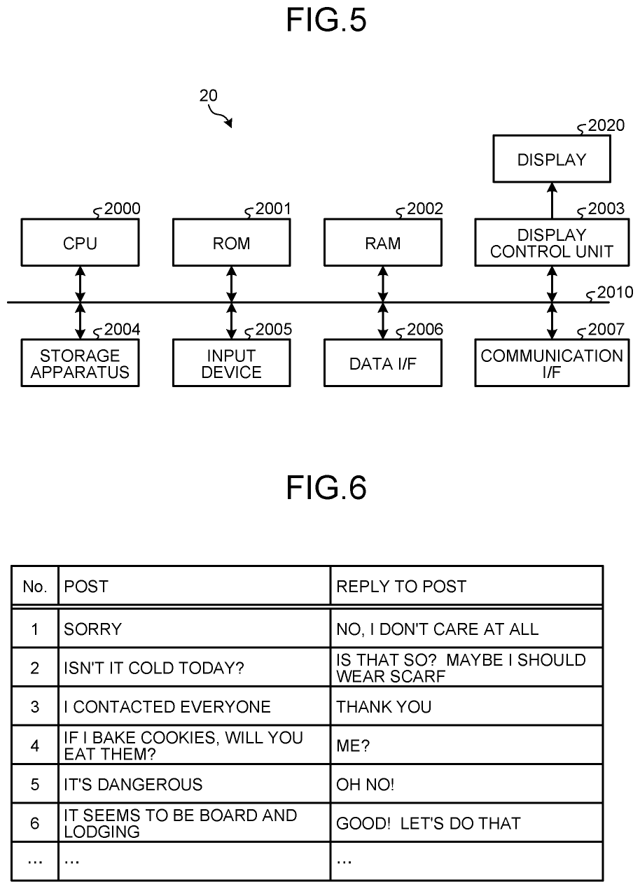

FIG. 5 is a block diagram illustrating a hardware configuration of an example of the terminal apparatus 20 applicable to the embodiment. In the drawing, the terminal apparatus 20 includes a CPU 2000, a ROM 2001, a RAM 2002, a display control unit 2003, a storage apparatus 2004, an input device 2005, a data I/F 2006, and a communication I/F 2007 which are communicably coupled to each other by a bus 2010.

The storage apparatus 2004 is a nonvolatile storage medium such as a hard disk drive or a flash memory. The CPU 2000 controls an operation of the terminal apparatus 20 by using the RAM 2002 as a work memory according to a program stored in the ROM 2001 and the storage apparatus 2004.

The display control unit 2003 generates a display signal displayable by a display 2020 based on a display control signal generated by the CPU 2000 according to the program, and supplies the display signal to the display 2020. As a result, a screen according to the display control signal is displayed on the display 2020.

The input device 2005 receives an input operation by the user, generates a control signal according to the input operation, and passes the control signal to the CPU 2000. The CPU 2000 can control the operation of the terminal apparatus 20 according to the control signal. Note that the input device 2005 may output a control signal corresponding to a contact position, and may be integrally formed with the display 2020 to have a touch panel configuration.

The data I/F 2006 is an interface for transmitting and receiving data to and from an external device in a wired or wireless manner. Universal Serial Bus (USB), Bluetooth (registered trademark), or the like can be applied as the data I/F 2006. The communication I/F 2007 performs communication via the network 2 under the control of the CPU 2000.

As described above, the information processing system 1 according to the embodiment is configured on the server 10 except for a portion of the data extraction unit 140. For example, the large-scale text data storage unit 100 and the line data storage unit 101 are configured in a predetermined storage area in the storage apparatus 2004 of the server 10. Furthermore, the speaker character determination unit 110, the versatility determination unit 120, the character score calculation unit 130, and the data extraction unit 140 are respectively configured as, for example, modules on a main storage area in the RAM 1002 by the CPU 1000 executing the information processing program according to the embodiment in the server 10.

For example, the information processing program can be acquired from an outside via the network 2 by communication via the communication I/F 1004 and installed on the server 10. The present disclosure is not limited thereto, and the information processing program may be provided by being stored in a detachable storage medium such as a compact disk (CD), a digital versatile disk (DVD), or a universal serial bus (USB) memory.

Furthermore, as described above, the terminal apparatus 20 is equipped with a portion of functions of the data extraction unit 140. The terminal apparatus 20 can realize the portion of functions of the data extraction unit 140 by, for example, a browser application mounted on the terminal apparatus 20. In this case, for example, the terminal apparatus 20 reads a program for causing the portion of functions of the data extraction unit 140 to be executed on the browser application from the server 10 via the network 2. The present disclosure is not limited thereto, and the program for executing the portion of functions of the data extraction unit 140 may be mounted on the terminal apparatus 20.

### 3. Details of Processing According to Embodiment

Next, the processing according to the embodiment will be described in more detail.

### (3-1. Processing by Speaker Character Determination Unit)

The processing by the speaker character determination unit 110 according to the embodiment described in step S10 in the flowchart of FIG. 3 will be described. The speaker character determination unit 110 uses, as inputs, the large-scale text data stored in the large-scale text data storage unit 100 and the line data of all the characters appearing in the target work stored in the line data storage unit 101.

FIG. 6 is a schematic diagram illustrating an example of the large-scale text data stored in the large-scale text data storage unit 100 applicable to the embodiment. Here, text data published over the Internet is collected as the large-scale text data. In particular, a text posted by a user on a social networking service (SNS), which is a service provided over the Internet, and a reply (response) to the post are paired and collected as the large-scale text data.

In FIG. 6, the large-scale text data includes items “utterance No”, “post”, and “reply to post”. The item “post” indicates a posted text, and the item “reply to post” indicates a reply to the item “post”. The item “utterance No” is a serial number for a pair of the item “post” and the item “reply to post”. In the example of FIG. 6, for example, in an utterance No [1], a posted text “Sorry” and an utterance text “No, I don't care at all” of a reply to the post are paired, and the utterance No [1] is attached.

The large-scale text data is not limited to the text of a post in the SNS collected from the Internet. For example, a text posted on a website over the Internet may be extracted and collected as the large-scale text data, or subtitle data of a movie may be collected. Furthermore, not only text data over the Internet but also text data held in a local environment can be collected as the large-scale text data. Further, not limited to the pair of the post and the reply to the post, only the reply may be collected as the large-scale text data. Furthermore, the large-scale text data is not limited to a text manually created like the post on the SNS or the subtitle of the movie, and can include a text automatically generated by a machine (artificial intelligence or the like).

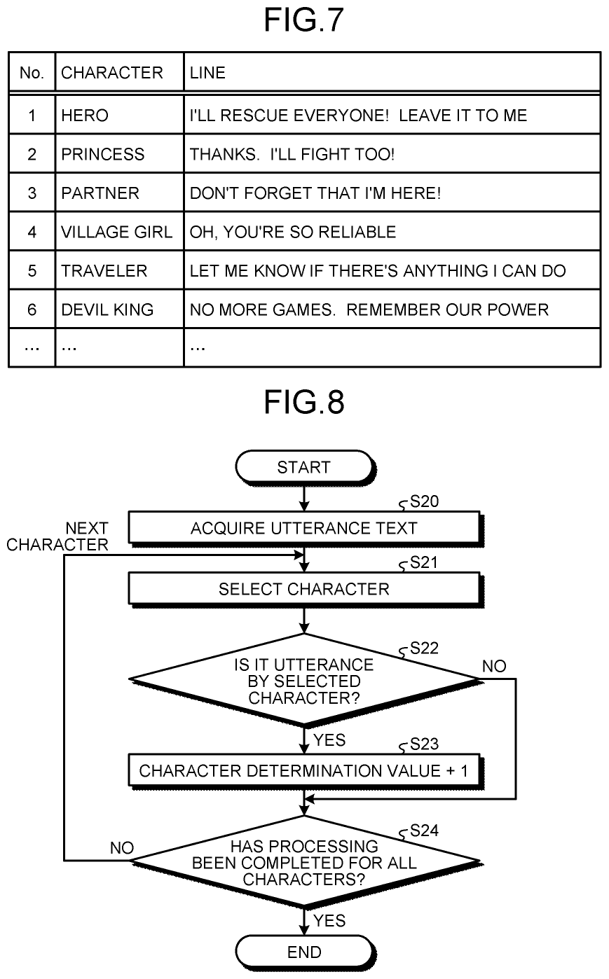

FIG. 7 is a schematic diagram illustrating an example of the line data stored in the line data storage unit 101 applicable to the embodiment. As described above, the line data storage unit 101 stores line data by all the characters appearing in the target work. The target work is content in which the target character appears, and is, for example, a novel or an animation. Furthermore, in the following example, it is assumed that the characters appearing in the target work are six persons of a “hero”, a “princess”, a “partner”, a “village girl”, a “traveler”, and a “devil king”.

Note that a type of the character is not particularly limited as long as the character is an entity that makes an utterance in the target work. For example, the character is not limited to a person, and may include an anthropomorphized animal, a plant, an inorganic substance, a simulated personality generated by a program, and the like.

In FIG. 7, the item “character” indicates a character, and the item “line” indicates a line by the corresponding character. Furthermore, the item “line No” is a serial number for a set of the items “character” and “line”. In the example of FIG. 7, for example, the line “I'll rescue everyone! Leave it to me” is associated with the character “hero”, and the line “Thanks. I'll fight too!” is associated with the character “princess”. Furthermore, in the example of FIG. 7, for the sake of description, each character is associated with one line, but actually, each character is associated with a plurality of lines, which are stored in the line data storage unit 101.

Returning to the description of the speaker character determination unit 110, the line data of all the characters of the target work stored in the line data storage unit 101 is used as learning data, and a binary classifier (speaker character determiner) that determines the speaker character of the utterance text is created by a certain machine learning method. This binary classifier corresponds to the speaker character determination unit 110.

Here, the method of machine learning for creating the binary classifier and the feature amount to be used are not particularly limited. For example, binary classification can be performed by logistic regression or a support vector machine with an appearance frequency or an importance (Term Frequency-Inverse Document Frequency (TF-IDF), or the like) of a word included in the utterance text as the feature amount. In addition, a classifier may be created by using a neural network.

As illustrated in FIG. 7, the speaker character determination unit 110 prepares a total of six types of binary classifiers for determining whether the speaker of the utterance text is the “hero”, whether the speaker is the “princess”, . . . , whether the speaker is the “devil king” respectively, when there are six characters of the “hero”, “princess”, “partner”, “village girl”, traveler”, and “devil king”.

FIG. 8 is a flowchart illustrating an example of processing by the speaker character determination unit 110 according to the embodiment. FIG. 8 illustrates processing for one piece of utterance data among the pieces of utterance data stored in the large-scale text data storage unit 100. Furthermore, the utterance data to be determined as the speaker character here is data of “reply to post” as described above. This is to measure the character characteristic of the text on the response side on the assumption that the text is used as the learning data for response generation.

Prior to the processing of the flowchart of FIG. 8, a character determination value for each character of the target work is initialized to a value=0. In FIG. 8, in step S20, the speaker character determination unit 110 acquires one utterance text from the large-scale text data storage unit 100. In the next step S21, the speaker character determination unit 110 selects a character (referred to as a determination character) to be subjected to the speaker character determination from among the characters appearing in the target work. In the example of FIG. 7, one person (for example, a “hero”) is selected from the “hero”, “princess”, “partner”, “village girl”, traveler”, and “devil king”.

In the next step S22, the speaker character determination unit 110 estimates the speaker of the utterance text acquired in step S20 by using the binary classifier corresponding to the determination character. Specifically, it is assumed that the utterance text acquired in step S20 is “No, I don't care at all” and the determination character is a “hero”, and the speaker character determination unit 110 determines whether the utterance text is estimated to be of the “hero”, in other words, whether the utterance content by the utterance text seems like the “hero”, by using a binary classifier for the determination character “hero”.

In step S22, when it is estimated that the utterance text acquired in step S20 is based on the determination character (step S22, “Yes”), the speaker character determination unit 110 causes the processing to proceed to step S23. In step S23, the speaker character determination unit 110 sets the character determination value of the determination character to a value=1, and causes the processing to proceed to step S24.

On the other hand, when it has not been estimated that the utterance text acquired in step S20 is based on the determination character (step S22, “No”), the speaker character determination unit 110 skips the processing of step S23 and causes the processing to proceed to step S24.

In step S24, the speaker character determination unit 110 determines whether the processing of steps S21 to S23 has been completed for all the characters included in the target work. When the speaker character determination unit 110 determines that there is a character for which the processing of steps S21 to S23 has not been completed yet among the characters included in the target work (step S24, “No”), the processing returns to step S21. The speaker character determination unit 110 selects one character from among the characters included in a next target work for which the processing of steps S21 to S23 has not been completed, and executes the processing of step S22 and subsequent steps.

On the other hand, when the speaker character determination unit 110 determines that the processing of steps S21 to S23 has been completed for all the characters included in the target work in step S24 (step S24, “Yes”), the speaker character determination unit 110 terminates the series of processing according to the flowchart of FIG. 8. Then, the speaker character determination unit 110 acquires a next utterance text from the large-scale text data storage unit 100, and executes the processing from step S20 again.

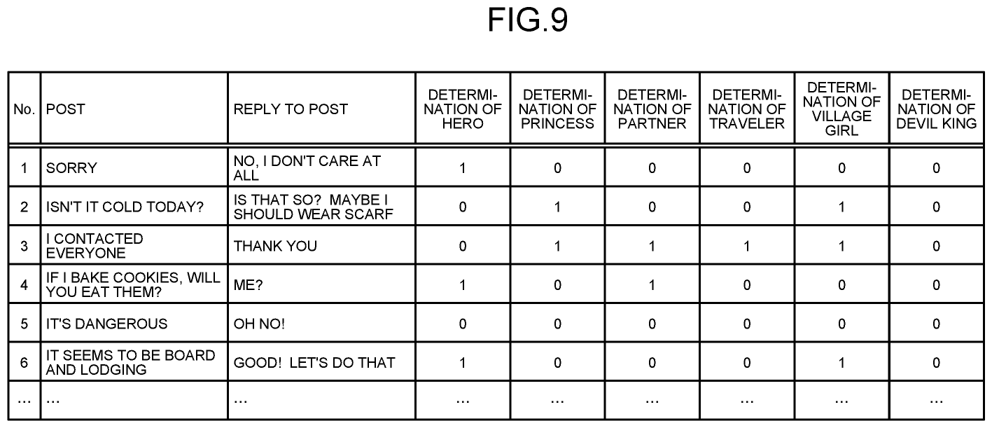

FIG. 9 is a schematic diagram illustrating an example of a result of the speaker character determination processing by the speaker character determination unit 110 according to the embodiment. In the example of FIG. 9, an example of a result of performing speaker character determination on each utterance text illustrated in FIG. 6 is illustrated. In FIG. 9, the text of the item “reply to post” is acquired by the speaker character determination unit 110 as the utterance text.

Furthermore, in FIG. 9, the item “determination of a hero” indicates the determination result (character determination value) in step S22 in a case where the determination character is a “hero”. It is indicated that the item “determination of a hero” has the character determination value=1, and the corresponding utterance text is estimated to be of the character “hero”, that is, the corresponding utterance text seems to be the character “hero”. Similarly, for the items “determination of a princess”, “determination of a partner”, “determination of a traveler”, “determination of a village girl”, and “determination of a devil king”, it is indicated that the character determination value=1, and each corresponding utterance text is estimated to be of the “princess”, “partner”, “traveler”, “village girl”, and “devil king”.

As an example, in the utterance text “No, I don't care at all” of the utterance No [1], only the item “determination of a hero” has the character determination value=1, and this utterance text is estimated to be of the character “hero”. That is, the speaker character of the utterance text of the utterance No [1] is estimated to be the character “hero”. On the other hand, in the utterance text “Good! Let's do that” of an utterance No [6], it is indicated that the items of “determination of a hero” and “determination of a village girl” have the character determination value=1, and the utterance text is estimated to be of the characters “hero” and “village girl”, and the speaker characters are the characters “hero” and “village girl”. That is, it has been determined that the utterance text of the utterance No [6] seems to be the character “hero” and also seems to be the character “village girl”.

As described above, the character determination value can be considered as a value indicating the degree of association of each character included in the target work with the utterance text.

The information indicating the result of the speaker character determination processing illustrated in FIG. 9 is stored, for example, in the storage apparatus 1003 or the RAM 1002 of the server 10 as an output of the speaker character determination unit 110.

Note that in the above description, the binary classifier is created by using the line data of “all characters” included in the target work as the learning data, but this is not limited to this example. For example, the binary classifier may be created by using line data of a character having a predetermined number of lines or more among all the characters included in the target work. For example, it is limited to a character having the number of lines of 100 or more among all the characters included in the target work, and the binary classifier is created based on the line data of the limited characters. In this case, in step S21 of FIG. 8, for example, it is conceivable to exclude a character with a line that has not been used to create the binary classifier from the selection target.

Furthermore, in the above description, the binary classifier is created based on the line data of all the characters of one target work, but this is not limited to this example. For example, a plurality of works may be set as target works, and characters of each of the plurality of works may be integrally handled.

### (3-2. Processing by Versatility Determination Unit)

Next, processing by the versatility determination unit 120 described in step S11 in the flowchart of FIG. 3 will be described. The versatility determination unit 120 uses the determination result by the speaker character determination unit 110 illustrated in FIG. 9 as an input. That is, the versatility determination unit 120 determines the presence or absence of versatility of each utterance text based on the result of the speaker character determination by the speaker character determination unit 110.

Here, the versatility of the utterance text indicates whether the utterance text depends on a specific character. That is, an utterance text with high versatility has low dependency on the specific character, and an utterance text with low versatility has high dependency on the specific character. More specifically, for example, the utterance text having high versatility is assumed to have a small sense of discomfort even in the utterance of any of the above-described characters “hero”, “princess”, “partner”, “traveler”, “village girl”, and “devil king”. On the other hand, the utterance text having low versatility, for example, having a particularly high dependency on the character “hero” is assumed to have a large sense of discomfort when used for an utterance of a character other than the character “hero”.

For the utterance text to be determined, the versatility determination unit 120 calculates a ratio of characters estimated to be the speakers of the utterance text from the result of the speaker character determination. In a case where the calculated ratio exceeds a threshold, the versatility determination unit 120 determines that the utterance text has versatility.

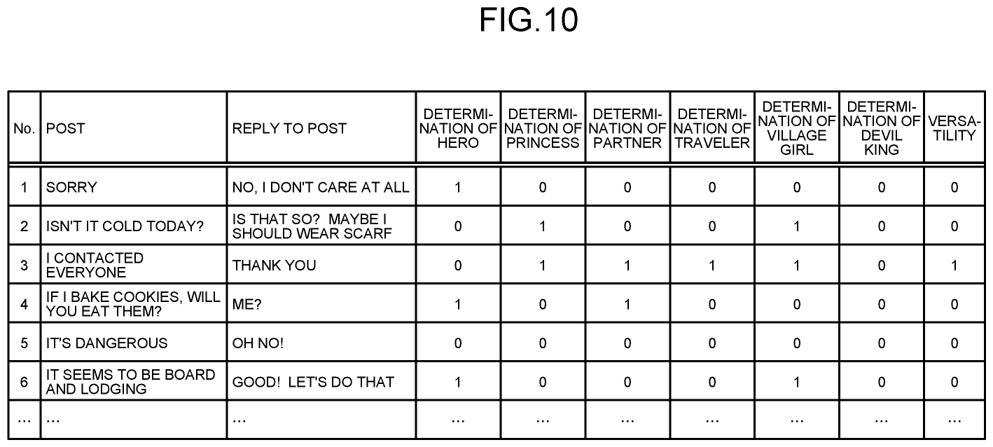

FIG. 10 is a schematic diagram illustrating an example of the determination result of the presence or absence of versatility by the versatility determination unit 120 according to the embodiment. In FIG. 10, an item “versatility” indicating the determination result of the presence or absence of versatility is added to FIG. 9 described above. In the utterance text determined to have low versatility, the item “versatility” has a value [0]. On the other hand, in the utterance text determined to have high versatility, the item “versatility” has a value [1].

In the example of FIG. 10, the threshold for the determination of the presence or absence of versatility is set to 60 [%]. For example, the utterance text “thank you” of an utterance No [3] is determined that four characters (characters “princess”, “partner”, “traveler”, and “village girl”) out of all six characters are speakers. In the utterance text of the utterance No [3], the ratio that the characters are determined to be the speakers is approximately 67 [%], which is larger than the threshold. Therefore, the utterance text “thank you” of the utterance No [3] is determined to have versatility.

On the other hand, for example, in the utterance text of an utterance No 2 “Is that so? Maybe I should wear a scarf”, it is determined that two characters (characters “princess” and “village girl”) out of all six characters are speakers. In the utterance text of the utterance No [2], the ratio that the characters are determined to be the speakers is approximately 33 [%], which is smaller than the threshold. Therefore, it is determined that the utterance text “Is that so? Maybe I should wear a scarf” of the utterance No [2] has no versatility.

The determination result by the versatility determination unit 120 is stored in, for example, the storage apparatus 1003 or the RAM 1002 of the server 10.

Note that in the above description, the threshold for the determination of the presence or absence of versatility is set to 60 [%], but this is merely an example, and this is not limited to this example.

Furthermore, in the above description, an arbitrary character among the characters included in the target work may be excluded from the characters used for the versatility determination. For example, in the above example, it is assumed that the character “devil king” is extremely different in an utterance property from other characters among all the characters “hero”, “princess”, “partner”, “traveler”, “village girl”, and “devil king” included in the target work. In such a case, the character “devil king” may be excluded from the versatility determination.

### (3-3. Processing by Character Score Calculation Unit)

Next, processing by the character score calculation unit 130 described in step S12 in the flowchart of FIG. 3 will be described. The character score calculation unit 130 uses the determination result by the speaker character determination unit 110 illustrated in FIG. 9 as an input. That is, the character score calculation unit 130 calculates a score indicating a character characteristic for each utterance text based on the result of the speaker character determination by the speaker character determination unit 110.

Note that the character characteristic of the utterance text means the target character likeness of the utterance text. For example, with respect to the utterance text in which the target character is not a speaker, when there is no sense of discomfort even when the target character utters the utterance text, it is assumed that the target character likeness of the utterance text is high. The character score of the utterance text is a value indicating the target character likeness of the utterance text.

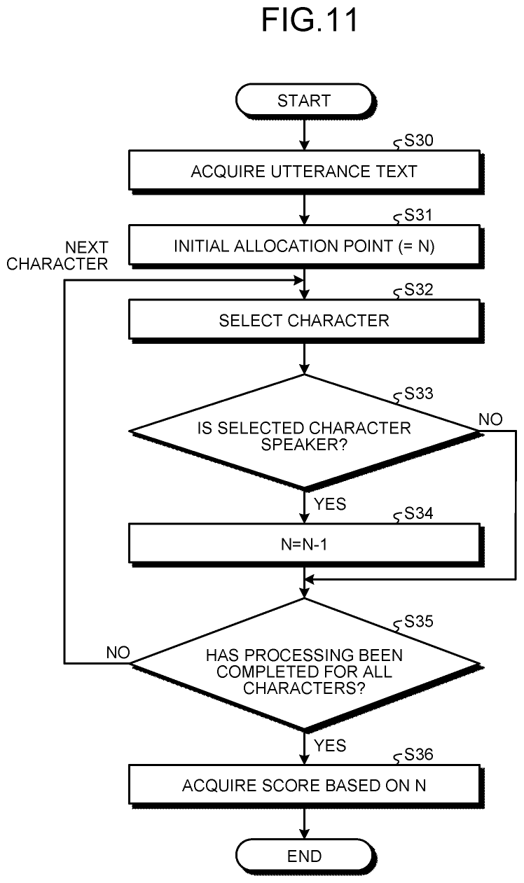

FIG. 11 is a flowchart illustrating an example of processing by the character score calculation unit 130 according to the embodiment. Prior to the processing according to the flowchart of FIG. 11, the character score calculation unit 130 designates one character among all the characters included in the target work as the target character. For example, in the above example, one person (for example, “a hero”) among the “hero”, “princess”, “partner”, “village girl”, traveler”, and “devil king” is selected as the target character.

In step S30, the character score calculation unit 130 acquires one utterance text from the large-scale text data storage unit 100. The acquired utterance text is referred to as a target utterance text.

In the next step S31, the character score calculation unit 130 sets an initial allocation point for the target character. For example, when the number of all characters in the target work is N, when it has been determined that the target character is a speaker of the target utterance text, N points are set as the initial allocation point for the target character. On the other hand, in a case where it is not determined that the target character is the speaker of the target utterance text, the character score calculation unit 130 sets 0 points as the initial allocation point for the target character.

In the next step S32, the character score calculation unit 130 selects one character from the remaining characters excluding the target character from all the characters included in the target work.

In the next step S33, the character score calculation unit 130 determines whether the character selected in step S32 is estimated to be the speaker of the target utterance text based on the determination result by the speaker character determination unit 110.

When the character score calculation unit 130 determines that the selected character is estimated to be the speaker of the target utterance text in step S33 (step S33, “Yes”), the character score calculation unit 130 causes the processing to proceed to step S34. In step S34, the character score calculation unit 130 sets a value obtained by subtracting one point from N points of the allocation point of the target character as a new allocation point of the target character, and causes the processing to proceed to step S35.

On the other hand, when the character score calculation unit 130 determines that the selected character has not been estimated to be the speaker of the target utterance text in step S33 (step S33, “No”), the character score calculation unit 130 cancels step S34 and causes the processing to proceed to step S35.

In step S35, the character score calculation unit 130 determines whether the processing of steps S32 to S34 has been completed for all the remaining characters excluding the target character from all the characters included in the target work. When the character score calculation unit 130 determines that the processing has not been completed for all the characters (step S35, “No”), the character score calculation unit 130 returns the processing to step S32 and executes the processing of steps S32 to S34 for the next character.

On the other hand, when the character score calculation unit 130 determines in step S35 that the processing has been completed (step S35, “Yes”), the character score calculation unit 130 causes the processing to proceed to step S36. In step S36, the character score calculation unit 130 acquires the character score of the target utterance text with respect to the target character based on the allocation point of N points.

After the processing of step S36, a series of processing according to the flowchart of FIG. 11 is completed. The processing according to the flowchart of FIG. 11 is repeatedly executed for all the utterance texts for which the speaker determination has been performed by the speaker character determination unit 110 for the target character. Furthermore, the processing according to the flowchart in FIG. 11 is repeatedly executed with all the characters included in the target work sequentially as the target characters.

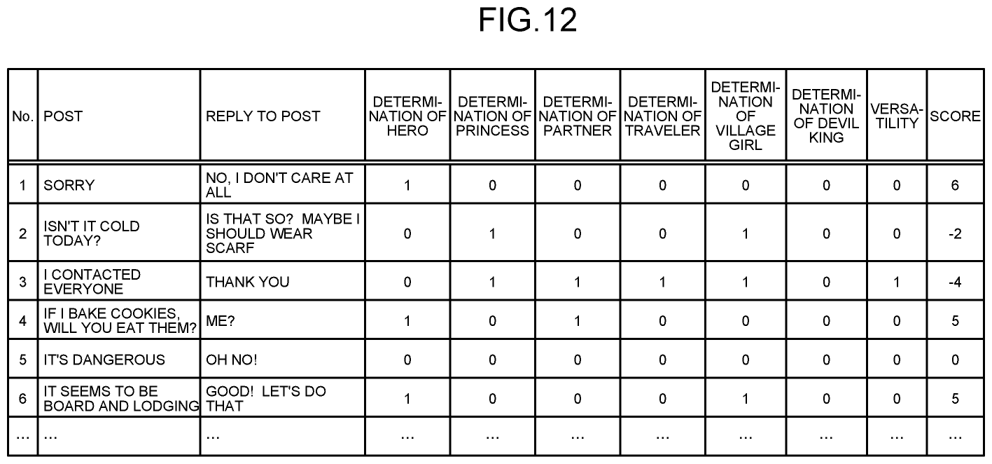

FIG. 12 is a schematic diagram illustrating an example of the character score acquisition result by the character score calculation unit 130 according to the embodiment. In FIG. 12, an item “score” indicating the character score is added to FIG. 10 described above.

As described in steps S33 and S34 of the flowchart of FIG. 11, when it is determined that a character selected from characters other than the target character is estimated to be the speaker of the target utterance text, one point is subtracted from N points of the initial allocation point of the target character to set a new allocation point. Assuming that the number of characters other than the target character estimated to be the speakers of the target utterance text is M, a score [N−M] obtained by subtracting M points from N points of the initial allocation point is set as the character score of the target utterance text with respect to the target character.

An example of the character score calculated by the character score calculation unit 130 will be described more specifically with reference to FIG. 12. As an example, in a case of an utterance text “Me?” of an utterance No [4], since the target character (character “hero”) is determined to be the speaker and the total number of characters is six, the score is the initial allocation point N=6 points. Next, in the utterance text, since the speaker is determined to be one character “partner” other than the target character, one point is deducted from the initial allocation point, and the character score of the character “hero” that is the target character is five points.

As another example, in the case of the utterance text “Is that so? Maybe I should wear a scarf” of the utterance No [2], since it has been determined that the target character (character “hero”) is not a speaker, the score is the initial allocation point N=0 points. Next, for the utterance text, since it is determined that the two characters “princess” and “village girl” other than the target character are the speakers, two points are deducted from the initial allocation point, and the character score of the character “hero”, which is the target character, is −2 points.

### (3-4. Processing by Data Extraction Unit)

Next, processing by the data extraction unit 140 described in step S13 in the flowchart of FIG. 3 will be described. The data extraction unit 140 uses, as inputs, the determination result (see FIG. 9) by the speaker character determination unit 110, the determination result (see FIG. 10) by the versatility determination unit 120, and the character score (see FIG. 12) calculated by the character score calculation unit 130. The data extraction unit 140 extracts target character utterance text based on the determination results and the character score.

The data extraction unit 140 extracts the target character utterance text by using a screen that presents the determination results and the character score as a user interface. The present disclosure is not limited thereto, and the data extraction unit 140 may automatically extract the target character utterance text based on conditions designated in advance for the determination results and the character score.

Here, a case where the target character utterance text is extracted according to an instruction of the user by using the user interface screen will be described.

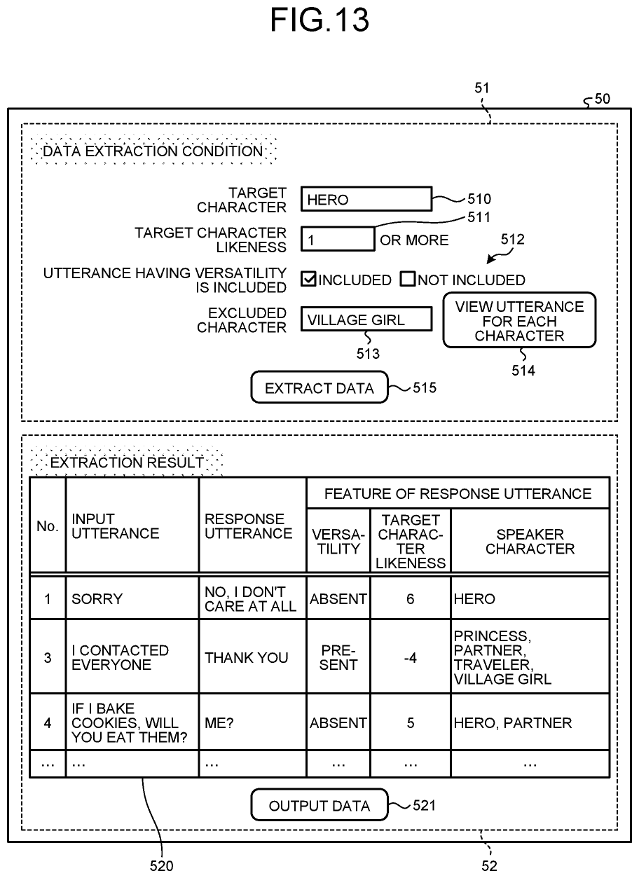

FIG. 13 is a schematic diagram illustrating an example of the data extraction screen as the user interface generated and presented by the data extraction unit 140 applicable to the embodiment. In FIG. 13, a data extraction screen 50 includes an extraction condition setting area 51 for setting a data extraction condition and an extraction result display area 52 in which a data extraction result is displayed.

The extraction condition setting area 51 is provided with input units 510, 511, 512, and 513 for the user to input the data extraction condition, and buttons 514 and 515 for executing processing according to the user operation.

A character name of the target character is input to the input unit 510. The input unit 510 can be configured to select the target character from a list of all characters of the target work by using, for example, a drop-down list or the like.

In the input unit 511, a target character likeness, that is, a condition of the character score is input. In the example of FIG. 13, the utterance text of which a value of the character score is a value input to the input unit 511 or more is set as the data extraction target. The input unit 511 can also be configured to select a desired value from a list of character scores that can be designated by using, for example, a drop-down list.

Whether the utterance text determined to have versatility is included in the extraction data is input to the input unit 512.

The input unit 513 excludes an utterance text in which the input character is included as a speaker character from data extraction target. The input unit 513 can be configured to select the target character from the list of all characters of the target work by using, for example, a drop-down list or the like. The button 514 displays an utterance text viewing screen (described later) for viewing the utterance text of the character input to the input unit 513 according to the user operation on the button 514.

The button 515 extracts the utterance text included in the large-scale text data stored in the large-scale text data storage unit 100 according to the conditions input to the input units 510 to 513 described above according to the user operation on the button 515. By operating the button 515, the utterance text selected based on each condition input to the input units 510 to 513 is extracted as extracted data 520 from the large-scale text data stored in the large-scale text data storage unit 100. The extracted data 520 is displayed in the extraction result display area 52.

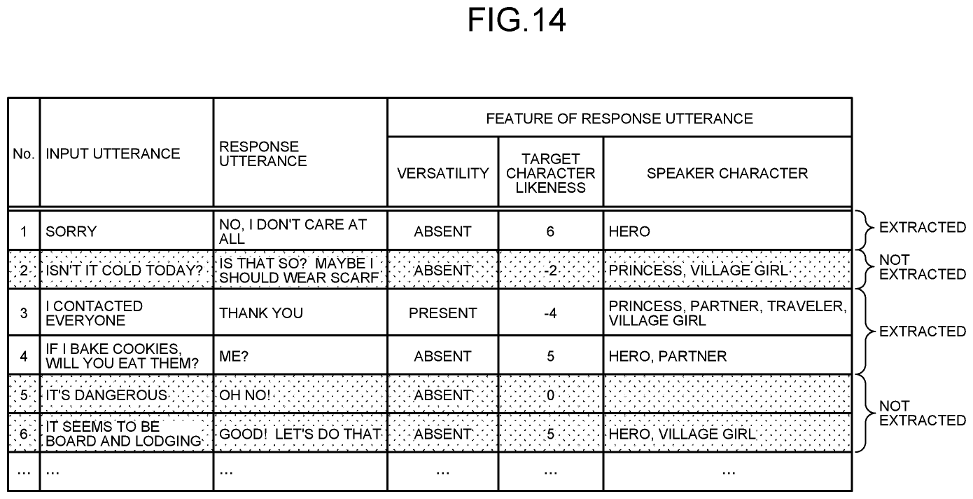

FIG. 14 is a schematic diagram for describing data extraction processing by the data extraction unit 140 according to the embodiment. In FIG. 14, an item “input utterance” corresponds to the item “post” in, for example, FIG. 9. An item “response utterance” is an utterance of a response to the item “input utterance”, and corresponds to, for example, the item “reply to post” in FIG. 9 and the like, and indicates an utterance text.

Furthermore, an item “feature of response utterance” includes three items of items “versatility”, “target character likeness”, and “speaker character”. The item “versatility” corresponds to, for example, the item “versatility” in FIG. 10, and indicates the presence or absence of versatility of the corresponding utterance text. The item “target character likeness” corresponds to, for example, the item “score” in FIG. 12. Furthermore, the item “speaker character” is, for example, a collection of the items “determination of a hero”, “determination of a princess”, “determination of a partner”, “determination of a traveler”, “determination of a village girl”, and “determination of a devil king” in FIG. 9, and characters determined as the speaker characters are listed for the utterance text.

Note that FIG. 14 is a collection of each data for description, and does not mean that the data extraction unit 140 holds each data in this form.

In the example of FIG. 13 described above, the character “hero” is set as the target character in the input unit 510, and the value=1 is set as the target character likeness in the input unit 511. Furthermore, the utterance having versatility is set to be included by the input unit 512, and the character “village girl” is set as the excluded character in the input unit 513.

The data extraction unit 140 selects an utterance text to be extracted from each utterance text shown in the item “response utterance” in FIG. 14 based on each input in FIG. 13.

First, in accordance with the settings of the input units 510, 511, and 513, the data extraction unit 140 extracts data that satisfies the conditions in which the target character likeness is 1 or more, the speaker character includes the character “hero”, and the speaker character does not include the character “village girl”. In the example of FIG. 14, the utterance Nos [1] and [4] satisfy the conditions. The data extraction unit 140 further extracts the utterance text that is considered to have versatility according to the setting of the input unit 512. In the example of FIG. 14, the utterance No [3] satisfies this condition.

The data extraction unit 140 extracts data of utterance Nos [1], [3], and [4] according to the settings of the input units 510 to 513. The extracted data 520 obtained by extracting the data of the utterance Nos [1], [3], and [4] in this manner is shown in the extraction result display area 52 of the data extraction screen 50 illustrated in FIG. 13.

Note that in the utterance No [3], the speaker character includes the character “village girl” that is the excluded character. In this case, when it is extracted because the item “versatility” is “present”, it is described that the excluded character may be included in the speaker character. This is because the utterance text having versatility is not limited to the excluded character “village girl”, and there is a possibility that other characters also utter.

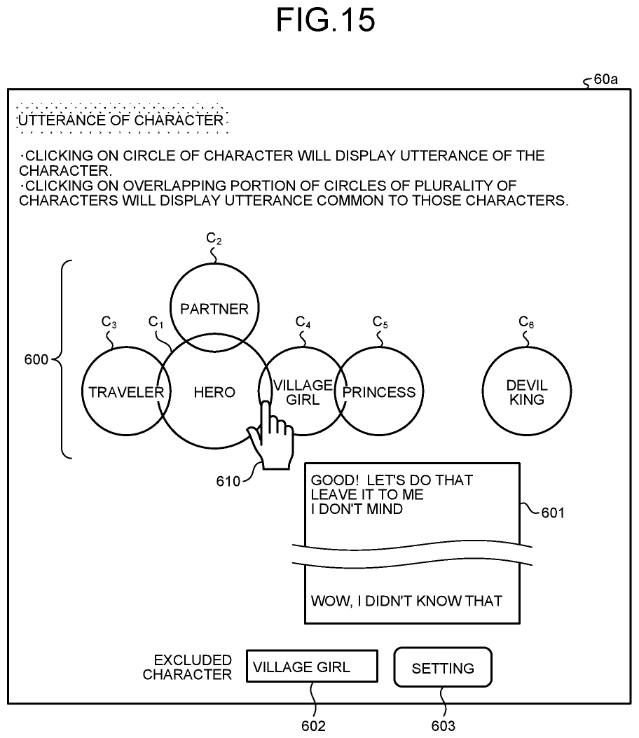

FIG. 15 is a schematic diagram illustrating an example of the utterance text viewing screen according to the embodiment. In FIG. 15, an utterance text viewing screen 60a is displayed by operating the button 514 on the data extraction screen 50 in FIG. 13.

The utterance text viewing screen 60a is provided with display areas 600 and 601, an input unit 602, and a button 603. In the display area 600, each character included in the target work is displayed. In the example of FIG. 15, each character is represented by circles C₁ to C₆, and the circle C₁ of the character “hero” that is the target character among the circles C₁ to C₆ is displayed largest.

Furthermore, in FIG. 15, for example, when the circles C₁ to C₆ are pointed by a cursor display 610 according to the operation of the cursor display 610 by the user, the data extraction unit 140 displays a list of utterance texts in which the pointed circle is estimated to be the speaker in the display area 601.

At this time, in a case where an overlapping portion of the circles is pointed out, the data extraction unit 140 displays utterance texts, in which characters corresponding to the respective circles sharing the overlapping portion are estimated to be speakers in common, as a list in the display area 601.

In the example of FIG. 15, the cursor display 610 points to an overlapping portion of the circle C₁ of the character “hero” and the circle C₄ of the character “village girl”. In the data extraction unit 140, utterance texts in which the character “hero” and the character “village girl” are estimated to be speakers in common are displayed in the display area 601. On the other hand, in a case where the cursor display 610 points to an overlapping portion of the circle C₁ of the character “hero” and the circle C₃ of the character “traveler”” where there is no speaker text in which the characters are estimated to be speakers in common, nothing is displayed in the display area 601.

Furthermore, for example, the user can select a desired circle from among the circles C₁ to C₆ displayed in the display area 600 by operating the cursor display 610 and move the selected circle in the display area 600. As a result, for example, it is possible to confirm the utterance text in which the character “hero” and another arbitrary character are estimated to be the speakers in common.

On the utterance text viewing screen 60a, the input unit 602 inputs a character that is preferably excluded as the speaker of the utterance text in the overlapping portion of the circles. In the example of FIG. 15, utterance texts in an overlapping portion of the circle C₁ of the character “hero” and the circle C₄ of the character “village girl” are displayed in the display area 601. The user confirms the utterance texts displayed in the display area 601, and even when it is the utterance text in which the character “hero” is estimated to be the speaker, thinks that it is better to exclude the utterance text common to the character “village girl” and inputs the character “village girl” as the excluded character to the input unit 602. The data extraction unit 140 reflects the content input to the input unit 602 in the data extraction result according to the operation on the button 603.

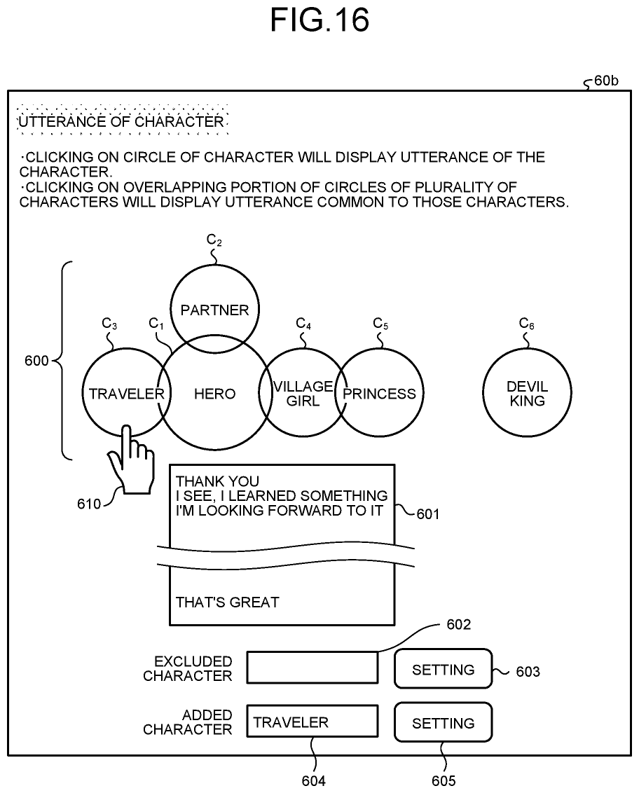

FIG. 16 is a schematic diagram illustrating another example of the utterance text viewing screen according to the embodiment. In FIG. 16, an utterance text viewing screen 60b is an example in which an input unit 604 and a button 605 are added to the utterance text viewing screen 60a illustrated in FIG. 15. The input unit 604 inputs the character added to the data extraction target by the data extraction unit 140. In the example of FIG. 16, when the user looks at the utterance texts in which the character “traveler” is assumed to be a speaker, the user thinks that most of the utterances have no problem even when the utterances are used as the utterance of the character “hero”, and inputs the character “traveler” to the input unit 604.

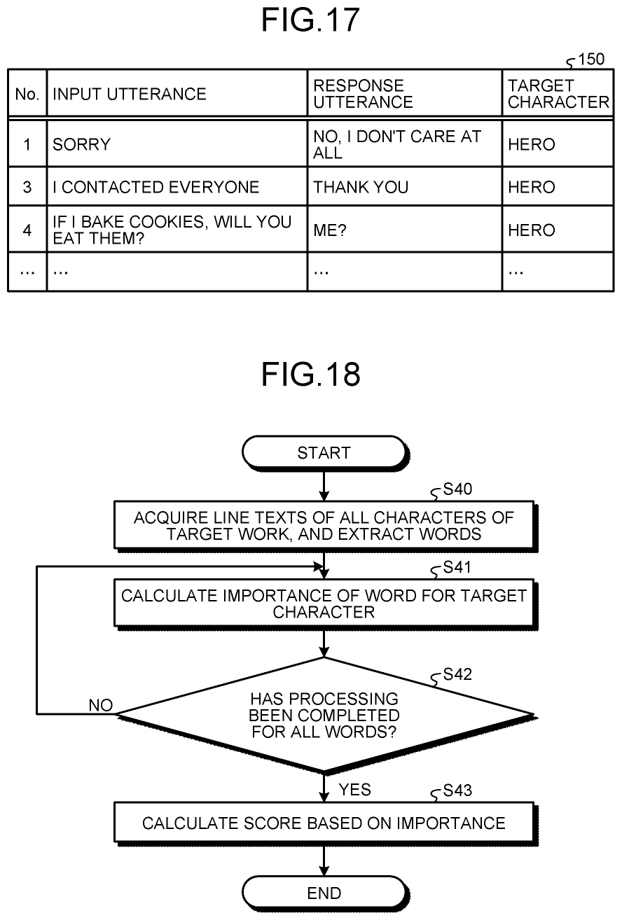

FIG. 17 is a schematic diagram illustrating an example of the target character text data 150 output by the data extraction unit 140 according to the embodiment. The target character text data 150 is output by the data extraction unit 140, for example, in response to an operation on a button 521 on the data extraction screen 50 in FIG. 13. In the example of FIG. 17, the target character text data 150 includes the item “utterance No” and the items “input utterance”, “response utterance”, and “target character”. The target character text data 150 includes each data extracted in FIG. 14.

The target character text data 150 may be stored in the terminal apparatus 20 or may be stored in a storage apparatus coupled to the terminal apparatus 20. Furthermore, the target character text data 150 may be transferred to the server 10 via the network 2 and stored in the server 10.

### 4. First Modification of Embodiment

Next, a first modification of the embodiment will be described. In the embodiment described above, the character score calculation unit 130 calculates the character score by using the determination result by the speaker character determination unit 110. On the other hand, in the first modification of the embodiment, the character score calculation unit 130 calculates the character score without using the determination result by the speaker character determination unit 110. More specifically, in the first modification of the embodiment, a probability that the target character is a speaker of the utterance text is calculated, and the calculated probability is used as a score.

The character score calculation unit 130 acquires a probability that a speaker of a certain utterance is a target character by creating a multi-valued classifier that estimates which character the speaker of each utterance text is. For example, the multi-valued classifier can be created by using logistic regression with the appearance frequency and importance (TF-IDF or the like) of the word included in the utterance text as the feature amount.

For example, the multi-valued classifier estimates which character included in the target work is the speaker of the target utterance text “I do not mind”. As an example, it is assumed that the probability that each character is a speaker of the target utterance text is, character “hero”=0.5, character “princess”=0.0, character “partner”=0.3, character “traveler”=0.2, character “village girl”=0.0, and character “devil king”=0.0. In this case, the character score of the character “hero” with respect to the target utterance text is set to 0.5.

The probability that each character is the speaker of the target utterance text can be considered as a value indicating the degree of association of each character included in the target work with the utterance text.

### 5. Second Modification of Embodiment

Next, a second modification of the embodiment will be described. Also in the second modification of the embodiment, similarly to the first modification of the embodiment described above, the character score calculation unit 130 calculates the character score without using the determination result by the speaker character determination unit 110. More specifically, in the second modification of the embodiment, the character score of the utterance text is calculated by using the importance of each word in each character.

FIG. 18 is a flowchart of an example illustrating processing by the character score calculation unit 130 according to the second modification of the embodiment. Prior to the processing according to the flowchart of FIG. 18, the character score calculation unit 130 designates one character among all the characters included in the target work as the target character. For example, in the above example, one person (for example, “a hero”) among the “hero”, “princess”, “partner”, “village girl”, traveler”, and “devil king” is selected as the target character.

In step S40, the character score calculation unit 130 acquires line texts of all characters of the target work, and extracts words as elements constituting the line text from each line text.

In the next step S41, the character score calculation unit 130 calculates the importance of one word t among the words extracted in step S40 for the target character of the word t according to the following Formula (1). Note that in Formula (1), Im(t) represents the importance of the word t, Fr(t) represents the frequency of appearance of the word t in the line text of the target character, and R(t) represents the rarity of the character uttering the word t respectively.

$$Im ( t ) = Fr ( t ) \times R ( t ) \qquad ( 1 )$$

Here, the rarity R(t) of the character uttering the word t can be calculated by, for example, the following Formula (2). Note that in Formula (2), N represents the number of all characters included in the target work, and M(t) represents the number of characters uttering the word t respectively.

$$R ( t ) = log ( N / M ( t ) ) \qquad ( 2 )$$

Note that the importance Im(t) of the word t is a value based on the rarity R(t) of the character uttering the word t, and can be considered as a value indicating the degree of association of each character included in the target work with the utterance text.

In the next step S42, the character score calculation unit 130 determines whether the processing has been completed for all the words extracted in step S40. When the character score calculation unit 130 determines that there is a word for which the processing of step S41 has not been executed yet among the words extracted in step S40 (step S42, “No), the character score calculation unit 130 returns the processing to step S41, and executes the processing of step S41 for a next word.

On the other hand, when the character score calculation unit 130 determines in step S42 that the processing has been completed for all the words extracted in step S40 (step S42, “Yes”), the character score calculation unit 130 causes the processing to proceed to step S43.

As described above, by calculating the importance of each word extracted from the line texts of all the characters of the target work for the target character, an importance of a word that hardly appears in the line text of the target character for the target character is lowered. Furthermore, by introducing the rarity R(t) of the character uttering the word t, the importance is lowered even in a case of an ordinary word uttered by any character. When it is a word that only the target character utters frequently, the importance of the word for the target character increases.

Note that as the frequency of appearance of the word t in the line text of the target character, a ratio of the word t in the number of appearances of all the words included in the line text of the target character can be used. The present disclosure is not limited thereto, and as the frequency of appearance of the word t in the line text of the target character, a ratio of the line text including the word t in all the line texts of the target character may be used.

In step S43, the character score calculation unit 130 calculates a character score indicating the target character likeness for each utterance text based on the importance Im(t) of each word obtained in the processing of steps S41 and S42. More specifically, for example, the character score calculation unit 130 calculates an average value of the importance of each word included in each utterance text for the target character as the character score of the entire utterance text.

For example, it is assumed that the utterance text to be the target of score calculation is “I/do/not/mind” and includes the words “I”, “do”, “not”, and “mind”. In a case where the importance of each word for the target character is, the word “I”=0.007, the word “do”=0, the word “not”=0, and the word “mind”=0.001, the character score calculation unit 130 calculates 0.002, which is an average value of the importance of the four words, as the character score of the utterance text with respect to the target character.

Note that in the above description, the portion “word” may be a “word string” including a plurality of words. For example, a word string including two words may be used. In the case of the utterance “I/do/not/mind”, the word strings including two words are “I/do”, “do/not”, and “not/mind”.

As described above, according to the information processing system 1 according to the embodiment and the first and second modifications thereof, it is possible to easily and automatically collect utterance text having a specific character likeness (character characteristic). Furthermore, it is possible to automatically evaluate the character characteristic of the utterance text included in the post to the SNS, subtitle data of a movie, or the like, and to extract a text having a specific character characteristic.

Even in the existing technology, an utterance text of a character can be obtained from a script of a novel or an animation, but since the amount of obtained data is very small, it is difficult to use the utterance text as the learning data for interactive response generation. On the other hand, in the information processing system 1 according to the embodiment and the first and second modifications thereof, it is possible to automatically collect a large amount of texts having a specific character likeness and to enhance the amount of data.

Furthermore, in the information processing system 1 according to the embodiment and the first and second modifications thereof, it is possible to specify an utterance (utterance having versatility) that is not strange even when the utterance is uttered by any character in the automatic evaluation of the character characteristic of the utterance text. Specifically, a binary classifier (character determiner) that determines whether the speaker of the utterance text is each character is prepared, and when a ratio of characters determined to be speakers exceeds a threshold, it is determined that the utterance text has versatility.

In the existing technology, only the character characteristic of the specific character has been considered. That is, in the existing technology, only a character determiner for a specific character has been used. Therefore, an utterance (an utterance that may originally be an utterance of the character) having versatility such as “thank you” may be determined as a negative example due to a small amount of learning data of the character determiner, or the like. On the other hand, by applying the information processing system 1 according to the embodiment and the first and second modifications thereof, it is possible to capture the utterance having versatility and add the utterance to the utterance text of each character.

Furthermore, according to the information processing system 1 according to the embodiment and the first and second modifications thereof, since the information processing system 1 includes the user interface that selects the utterance text based on the determination result of the speaker character, the automatic evaluation value of the character characteristic, and the presence or absence of versatility, it is possible to easily create the corpus of the utterance text.

### 6. Third Modification of Embodiment

Next, a third modification of the embodiment will be described. In the embodiment and the first and second modifications thereof described above, large-scale text data is collected as content data from the Internet or the like, and the character score of the utterance text included in the collected large-scale text data is calculated. The content data applicable to the embodiment is not limited to the text data. A third modification of the embodiment is an example in which moving image data or music data (audio data) is applied as the content data.

The information processing system 1 according to the embodiment and the first and second modifications thereof described above associates the character of the target work with the utterance text included in the large-scale text data. On the other hand, the information processing system according to the third modification of the embodiment collects moving image data and music data published over the Internet or the like.

The information processing system according to the third modification of the embodiment fragments collected moving image data and music data in a predetermined unit, and labels each fragmented fragment. The information processing system determines an author likeness of each labeled fragment with respect to each of one or a plurality of authors of predetermined moving image data or music data, for example, in a similar manner to the processing according to the above-described embodiment.

Note that the predetermined moving image data or music data described here is data of which the author is clear. On the other hand, the author of the fragmented moving image data or music data collected from the Internet or the like is not necessarily clear in some cases.

That is, each fragment in the third modification of the embodiment corresponds to the utterance text in the embodiment and the first and second modifications thereof described above. Furthermore, in the third modification of the embodiment, the author of which the author likeness is determined corresponds to the target character in the embodiment and the first and second modifications thereof described above.

Here, as the fragment in the moving image data, a clip or a scene constituting the moving image data can be applied. Furthermore, as the fragment in the music data, each portion, a phrase, a section divided by a tone or a beat change, or the like in the configuration of the music such as a prelude, a first melody, a second melody, a chorus, an interlude, and a postlude can be applied.

As described above, in the third modification of the embodiment, it is possible to associate a specific author with the fragment of moving image data or music data collected from the Internet or the like. Note that in a case of using the moving image data or music data associated with the specific author, it is necessary to sufficiently consider copyright and the like.

Furthermore, the effects described in the present specification are merely examples and are not limited, and other effects may be provided.

Note that the present technology can also have the following configurations.

(1) An information processing apparatus comprising:
a score calculation unit configured to calculate a score indicating a target character likeness of first content data based on a feature amount indicating a feature of the first content data and a degree of association of the target character with other characters different from the target character with respect to the first content data; and
an extraction unit configured to extract data to be associated with the target character among the first content data based on the score calculated by the score calculation unit.

(2) The information processing apparatus according to the above (1),
further comprising:
a versatility determination unit configured to determine presence or absence of versatility of the first content data based on the degree of association, wherein
the score calculation unit
calculates the score by excluding the first content data determined to have the versatility by the versatility determination unit from the first content data.

(3) The information processing apparatus according to the above (2), wherein
the extraction unit
extracts the data based on the score and the presence or absence of the versatility determined by the versatility determination unit.

(4) The information processing apparatus according to any one of the above (1) to (3),
further comprising:
an association determination unit configured to perform an association determination for determining to which of each of the target character and the other characters the first content data is associated.

(5) The information processing apparatus according to the above (4), wherein
the association determination unit
performs the association determination by performing binary classification of each of the target character and the other characters with respect to the first content data.

(6) The information processing apparatus according to the above (5), wherein
the score calculation unit
calculates the score by giving an initial allocation point to each of the target character and the other characters and subtracting a result of the binary classification by the association determination from the initial allocation point.

(7) The information processing apparatus according to any one of the above (1) to (3), wherein
the score calculation unit
calculates the score based on a result of multi-valued classification of each of the target character and the other characters with respect to the first content data.

(8) The information processing apparatus according to any one of the above (1) to (3), wherein
the score calculation unit
calculates the score based on an importance by obtaining the importance of each element constituting each second content data corresponding to each of the target character and the other characters with respect to the target character.

(9) The information processing apparatus according to the above (8), wherein
the score calculation unit
obtains the importance based on a number of pieces of the second content data associated with the target character and rarity of the second content data in each of the target character and the other characters.

(10) The information processing apparatus according to any one of the above (4) to (8), wherein
the association determination unit
performs the association determination when the number of pieces of the second content data associated with the target character among each second content data associated with each of the target character and the other characters is a predetermined number or more.

(11) The information processing apparatus according to any one of the above (1) to (10), wherein
the extraction unit
generates a designation screen provided with a condition designation unit for designating at least the target character and a lower limit value of the score as a condition related to extraction of the data.

(12) The information processing apparatus according to the above (11), wherein
the extraction unit is further provided with, on the designation screen,
an excluded character designation unit configured to designate a character to be excluded from a target of the data extraction among the target character and the other characters, and
a display designation unit configured to designate display of a viewing screen for viewing second content data associated with each of the target character and the other characters.

(13) The information processing apparatus according to the above (12), wherein
the extraction unit is
provided with, on the viewing screen, an additional designation unit configured to designate a character to be added as a new target character with respect to the target character among the other characters.

(14) The information processing apparatus according to any one of the above (1) to (13), wherein the first content data is text data.

(15) The information processing apparatus according to the above (14), wherein
the target character and the other characters are characters appearing in a target work, and
the score calculation unit
obtains the degree of association by using line data indicating lines of the target character and the other characters in the target work.

(16) The information processing apparatus according to the above (14) or (15), wherein
the first content data is text data posted on a social networking service (SNS).

(17) The information processing apparatus according to the above (16), wherein
the score calculation unit
calculates the score by using a response to the post as the first content data.

(18) The information processing apparatus according to any one of the above (1) to (13), wherein
the first content data is video data.

(19) The information processing apparatus according to any one of the above (1) to (13), wherein
the first content data is music data.

(20) The information processing apparatus according to any one of the above (1) to (19), wherein
the first content data is data published over the Internet.

(21) An information processing method, executed by a processor,
the method comprising:
a score calculation step of calculating a score indicating a target character likeness of first content data based on a feature amount indicating a feature of the first content data and a degree of association of the target character with other characters different from the target character with respect to the first content data; and
an extraction step of extracting data to be associated with the target character among the first content data based on the score calculated in the score calculation step.

### REFERENCE SIGNS LIST

1 INFORMATION PROCESSING SYSTEM
2 NETWORK
10 SERVER
20 TERMINAL APPARATUS
50 DATA EXTRACTION SCREEN
51 EXTRACTION CONDITION SETTING AREA
52 EXTRACTION RESULT DISPLAY AREA
60a, 60b UTTERANCE TEXT VIEWING SCREEN
100 LARGE-SCALE TEXT DATA STORAGE UNIT
101 LINE DATA STORAGE UNIT
110 SPEAKER CHARACTER DETERMINATION UNIT
120 VERSATILITY DETERMINATION UNIT
130 CHARACTERISTIC SCORE CALCULATION UNIT
140 DATA EXTRACTION UNIT
150 TARGET CHARACTER TEXT DATA
510, 511, 512, 513, 602, 604 INPUT UNIT
514, 515, 521, 603, 605 BUTTON
520 EXTRACTED DATA
600, 601 DISPLAY AREA

1. An information processing apparatus comprising:
a score calculation unit configured to calculate a score indicating a target character likeness of first content data based on a feature amount indicating a feature of the first content data and a degree of association of the target character with other characters different from the target character with respect to the first content data; and
an extraction unit configured to extract data to be associated with the target character among the first content data based on the score calculated by the score calculation unit.

2. The information processing apparatus according to claim 1,
further comprising:
a versatility determination unit configured to determine presence or absence of versatility of the first content data based on the degree of association, wherein
the score calculation unit
calculates the score by excluding the first content data determined to have the versatility by the versatility determination unit from the first content data.

3. The information processing apparatus according to claim 2, wherein
the extraction unit
extracts the data based on the score and the presence or absence of the versatility determined by the versatility determination unit.

4. The information processing apparatus according to claim 1,
further comprising:
an association determination unit configured to perform an association determination for determining to which of each of the target character and the other characters the first content data is associated.

5. The information processing apparatus according to claim 4, wherein
the association determination unit
performs the association determination by performing binary classification of each of the target character and the other characters with respect to the first content data.

6. The information processing apparatus according to claim 5, wherein
the score calculation unit
calculates the score by giving an initial allocation point to each of the target character and the other characters and subtracting a result of the binary classification by the association determination from the initial allocation point.

7. The information processing apparatus according to claim 1, wherein
the score calculation unit
calculates the score based on a result of multi-valued classification of each of the target character and the other characters with respect to the first content data.

8. The information processing apparatus according to claim 1, wherein
the score calculation unit
calculates the score based on an importance by obtaining the importance of each element constituting each second content data corresponding to each of the target character and the other characters with respect to the target character.

9. The information processing apparatus according to claim 8, wherein
the score calculation unit
obtains the importance based on a number of pieces of the second content data associated with the target character and rarity of the second content data in each of the target character and the other characters.

10. The information processing apparatus according to claim 4, wherein
the association determination unit
performs the association determination when the number of pieces of the second content data associated with the target character among each second content data associated with each of the target character and the other characters is a predetermined number or more.

11. The information processing apparatus according to claim 1, wherein
the extraction unit
generates a designation screen provided with a condition designation unit for designating at least the target character and a lower limit value of the score as a condition related to extraction of the data.

12. The information processing apparatus according to claim 11, wherein
the extraction unit is further provided with, on the designation screen,
an excluded character designation unit configured to designate a character to be excluded from a target of the data extraction among the target character and the other characters, and
a display designation unit configured to designate display of a viewing screen for viewing second content data associated with each of the target character and the other characters.

13. The information processing apparatus according to claim 12, wherein
the extraction unit is
provided with, on the viewing screen, an additional designation unit configured to designate a character to be added as a new target character with respect to the target character among the other characters.

14. The information processing apparatus according to claim 1, wherein
the first content data is text data.

15. The information processing apparatus according to claim 14, wherein
the target character and the other characters are characters appearing in a target work, and
the score calculation unit
obtains the degree of association by using line data indicating lines of the target character and the other characters in the target work.

16. The information processing apparatus according to claim 14, wherein
the first content data is text data posted on a social networking service (SNS).

17. The information processing apparatus according to claim 16, wherein
the score calculation unit
calculates the score by using a response to the post as the first content data.

18. The information processing apparatus according to claim 1, wherein
the first content data is video data.

19. The information processing apparatus according to claim 1, wherein
the first content data is music data.

20. The information processing apparatus according to claim 1, wherein
the first content data is data published over the Internet.

21. An information processing method, executed by a processor,
the method comprising:
a score calculation step of calculating a score indicating a target character likeness of first content data based on a feature amount indicating a feature of the first content data and a degree of association of the target character with other characters different from the target character with respect to the first content data; and
an extraction step of extracting data to be associated with the target character among the first content data based on the score calculated in the score calculation step.
